(19) United States
(12) Patent Application Publication
(10) Pub. No.: US 2023/0023563 A1
(43) Pub. Date: Jan. 26, 2023

(54) System for Simultaneous Content Updates to Multiple Websites and Web-Enabled Forms

(71) Applicant: Janover, Inc., Boca Raton, FL (US)

(72) Inventors: Blake Elliot Janover, Boca Raton, FL (US); Mykyta Drozd, Kyiv (UA); Sozanskyi Vsevolod, Kyiv (UA)

(73) Assignee: Janover Inc., Boca Raton, FL (US)

(21) Appl. No.: 17/869,559

(22) Filed: Jul. 20, 2022

Related U.S. Application Data
(60) Provisional application No. 63/223,843, filed on Jul. 20, 2021.

(51) Int. Cl. H04L 67/55; G06F 40/174

(52) U.S. Cl. CPC H04L 67/55; G06F 40/174

(57) ABSTRACT

Systems and methods for simultaneously providing updated data to multiple websites and web-enabled forms are described. The system includes a computer having a processor and associated memory, an input device communicatively connected to the computer, a communications network, and at least two web assets, each web asset including data. The system also includes a flow builder process for creating updated data using the input device and the computer. The system further includes a push process for pushing the updated data to the at least two web assets so that the data of the at least two web assets is changed simultaneously to include or to be replaced by the updated data.

### CROSS-REFERENCE TO RELATED APPLICATIONS

This application is a nonprovisional application of and claims priority from U.S. provisional patent application Ser. No. 63/223,843 filed on Jul. 20, 2021. The foregoing application is incorporated in its entirety herein by reference.

### FIELD OF THE INVENTION

The invention relates to websites and web-enabled forms. More particularly, the invention relates to systems and methods for simultaneously providing an update to multiple websites and web-enabled forms.

### BACKGROUND

The Internet and proliferation of websites and web-enabled forms to quickly gather data from remote parties has facilitated business and particularly commerce related to services. However, no quick and efficient means have been developed for updating data, e.g., information and forms for collecting information, across multiple websites and web-enabled forms simultaneously so that each such site and form includes the same updated information. Using conventional tools, such updating often must be completed by persons who are knowledgeable and experienced with information technology or website development and is not easily performs by persons who lack such knowledge and expertise.

A need exists for systems and methods for simultaneously pushing updated data to multiple websites and web-enabled forms. A need also exists for systems and methods for allowing non-technical staff to create and push updated data simultaneously to multiple websites and web-enabled forms.

### SUMMARY

The invention relates to systems and methods for simultaneously updating multiple web assets, such as websites and web-enabled forms, with new (i.e., updated) data that adds to or replaces other data on the web asset. The systems and methods allow service providers, e.g., lenders, mortgage brokers, loan processors, lending lead generators, and others, to collect information from users (e.g., borrowers or potential customers) from across multiple web assets using standardized questions and data requests. For example, a mortgage lender may have multiple websites each of which includes a loan application form or potential borrower questionnaire. Previously, the mortgage lender would have to modify each website separately when information is desired or required to be changed, e.g., in response to changes in government lending regulations. However, using the systems and methods described herein, all of the mortgage lenders websites may be modified simultaneously using a flow builder process to create new updated data and then using a push process to push the updated data to the mortgage lender's multiple websites in order to add to or replace data appearing on those websites. Such data and updated data can be informational. The data and updated data may also be form fields used to collect information from a borrower or a potential borrower. Such form fields may include text fields in which the user may type a response to a question that is presented in relation to that particular form field. The form field can also be a binary answer field (e.g., “yes” or “no”), a document field, a number field for inserting or selecting responses that are numerical, or a multiple choice field that allows the user to select responses chosen from predetermined answer options.

The flow builder process (also called a workflow builder) is a tool that aids in creating a form field-based sequence. This form field-based sequence is used to collect application data from the demand side of the commercial capital market (i.e., multifamily and commercial real estate borrowers) and to submit this data as a loan application package to the supply side (i.e., capital lenders). The information collected from the form field-based sequence may also be used to create and generate leads that are provided to other parties, e.g., other lenders, mortgage brokers, real estate agents, retailers, contractors, etc.

The workflow builder allows non-technical staff to create and push highly conditional question sequences as workflows simultaneously across various web assets near-instantaneously. By avoiding the necessity of having such web asset updating being performed by technical workers such as informational technology (IT) or website development personnel, the system allows for more creativity in an organization since non-technical staff are able to create their own form-field based sequences. Allowing non-technical staff to perform such actions also reduces process bottlenecks, for example, where IT or website development personnel are unable to handle immediately the implementation of updates to web assets.

Accordingly, the invention features a system for simultaneously providing an update to multiple websites and web-enabled forms. The system includes a computer having a processor and associated memory, an input device communicatively connected to the computer, a communications network, and at least two web assets, each web asset including data. The system also includes a flow builder process for creating updated data using the input device and the computer. The system further includes a push process for pushing the updated data to the at least two web assets so that the data of the at least two web assets is changed simultaneously to include or to be replaced by the updated data.

In another aspect, the invention can also feature each of the at least two web assets being or including a web site or a web-enabled form.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a text form field of a system for simultaneously updating content on multiple websites and web-enabled forms.

FIG. 2 is a binary answer form field of the system of FIG. 1.

FIG. 3 is a document form field of the system of FIG. 1.

FIG. 4 is a number form field of the system of FIG. 1.

FIG. 5 is a multiple choice form field of the system of FIG. 1.

FIG. 6 is a detailed close-up of a property flowchart of a flow builder of the system of FIG. 1.

FIG. 7 is a detailed close-up of a borrower flowchart of a flow builder of the system of FIG. 1.

FIG. 8 is a detailed close-up of a financial flowchart of a flow builder of the system of FIG. 1.

FIG. 9 is a detailed close-up of a SBA loan flowchart of a flow builder of the system of FIG. 1.

FIG. 10 is an illustration of a conditional IF sequence related to missed mortgage payments in the financial flowchart of FIG. 8.

FIG. 11 shows a button embedded on a webpage as an entry into a question flow.

FIG. 12 shows a form field embedded on a webpage showing a first question in a sequence of a flow builder of the system of FIG. 1.

FIG. 13 shows question form fields as viewed on a portal to which a user is forwarded to complete a sequence of the flow builder.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

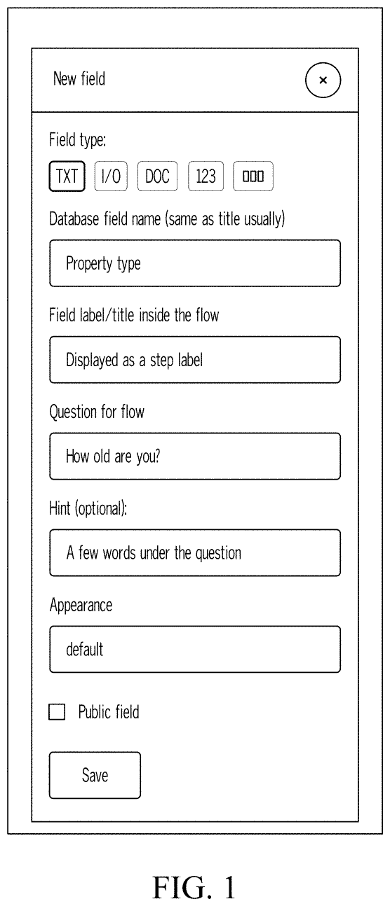

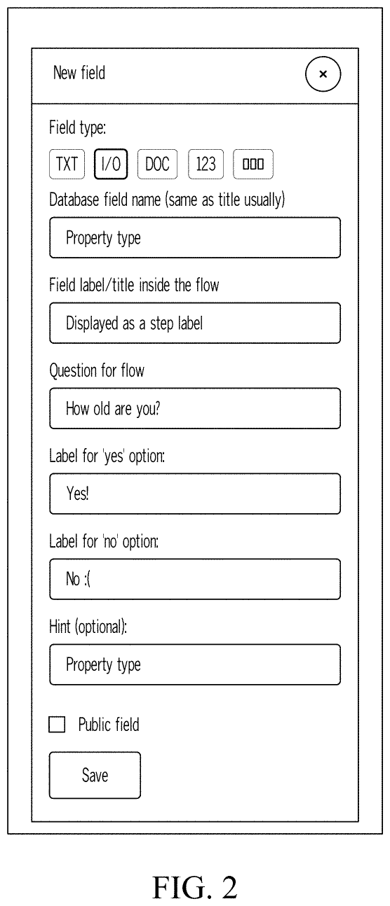

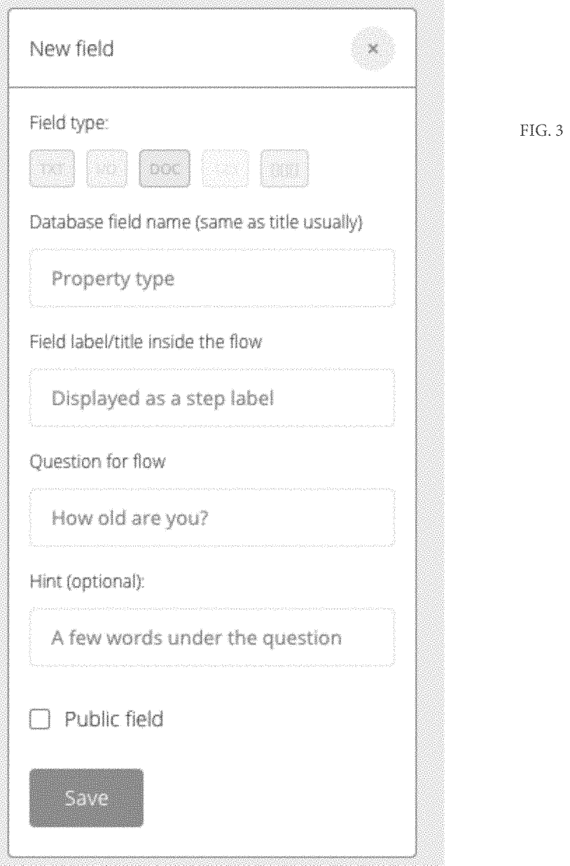

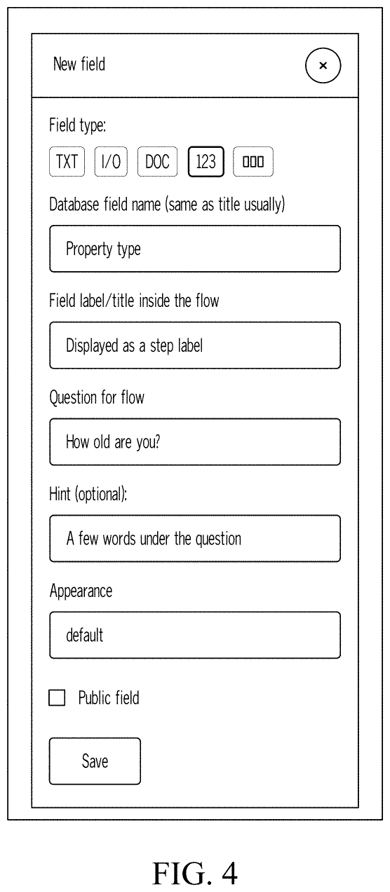

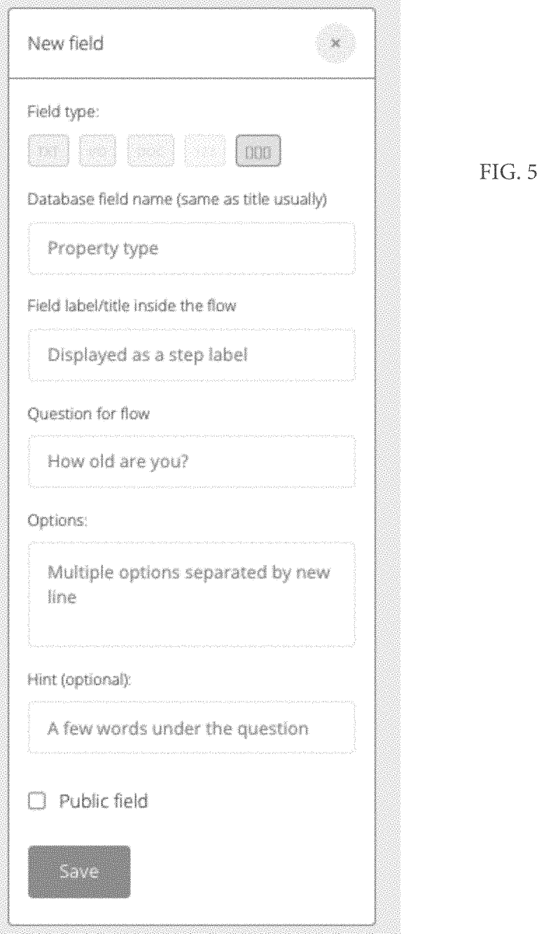

The invention provides a system for simultaneously providing an update to multiple websites and web-enabled forms. The system includes a computer having a processor and associated memory, an input device communicatively connected to the computer, a communications network, and at least two web assets, each web asset including data. As shown in FIGS. 1-13, the system also includes a flow builder process for creating updated data using the input device and the computer. The flow builder process may also be referred to herein as a workflow builder process or a workflow builder. The system further includes a push process for pushing the updated data to the at least two web assets so that the data of the at least two web assets is changed simultaneously to include or to be replaced by the updated data.

The computer is a desktop computer, laptop computer, tablet computer, mobile computing device (e.g., a smartphone), or any other computing device having a processor, associated memory, and a network connection for communicatively connecting to the communications network. Some embodiments of the system may include more than one computer. The computer includes a connected display screen or an integrated display screen so that a user may view a graphical user interface to use certain features of software that forms part of the system. The user of the flow builder process can be a lender or other administrator of the system who uses the computer to access the flow builder process. The user of the web asset is typically a borrower, who submits information through the web asset to the lender in response to questions created by the user of the flow builder process.

The input device is a physical keyboard, a virtual keyboard, a computer mouse, a touchscreen display, a microphone and text-to-speech software or software for converting verbal commands received by the microphone into actions implemented by the computer, a combination of two or more of the foregoing input devices, or any other suitable input device.

The communications network is the Internet, a local area network (LAN), a wide area network (WAN), a WiFi network, a cellular network, or any other suitable communications network. The communications network can be wired or wireless.

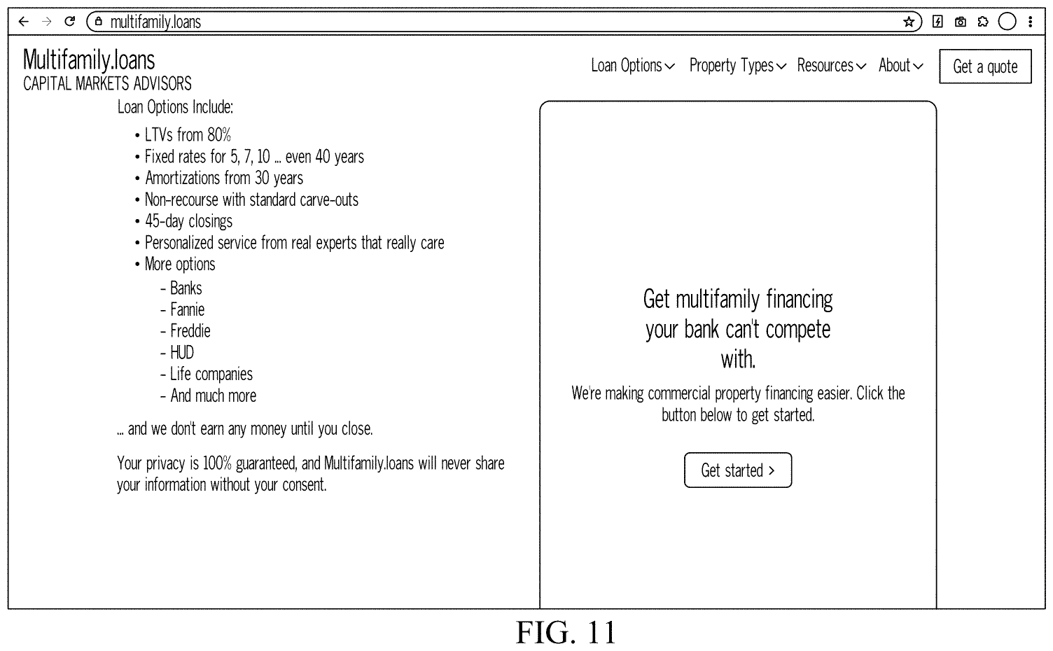

The at least two web assets can be websites, web-enabled forms or documents, or a combination of both. Examples of websites also include blogs and landing pages. As shown in FIGS. 11-13, parts of the system, e.g., the flow builder process, can be embedded in the at least two web assets. For example, the flow builder process may be embedded on a landing page of a website and connected to data collection software. One example of such data collection software is a customer relation management (CRM) application that allows completed form fills to be collected continuously and automatically from an unlimited number of sources.

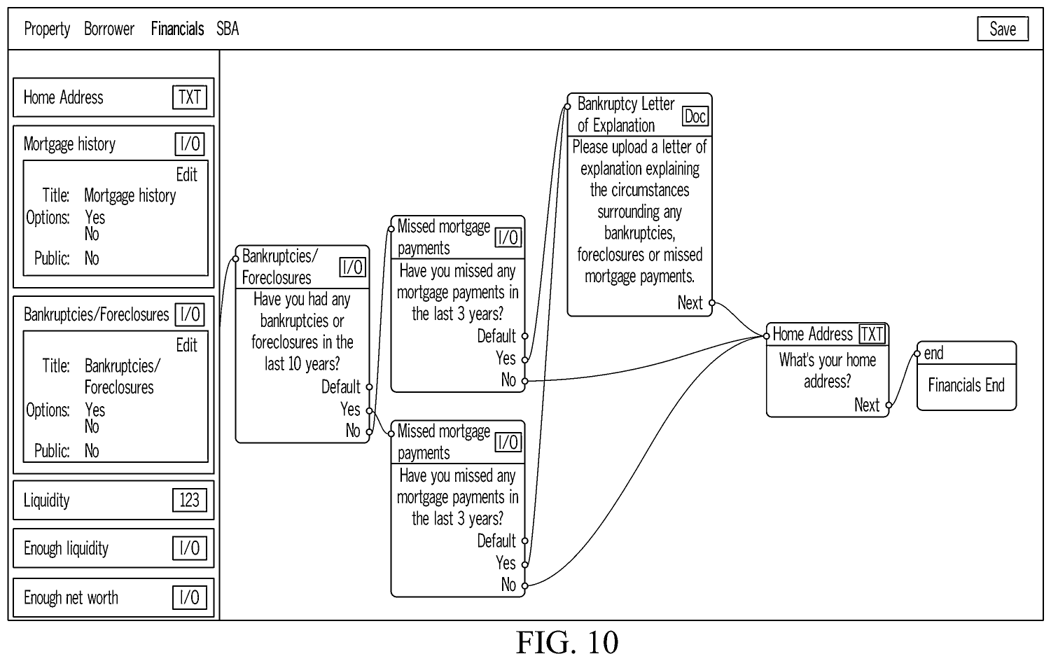

The flow builder process is used by a user to create one or more form field-based sequences (e.g., highly conditional question sequences or a data entry flow) that may be pushed by the push process to at least two web assets, although in some embodiments, the updated data may be pushed to only a single web asset. A particular field can be used twice in a form field-based sequence created using the flow builder process twice to natively incorporate a conditional “if” sequence in a flow, which allows conditional branching (as shown in FIG. 10) to be more robust. As shown in FIGS. 1-5, the flow builder process may use any of several data entry field types including, for example, text fields, binary answer fields (e.g., yes or no), document fields, number fields, and multiple choice fields. These data entry field types can include common properties such as a database field name, a field label/title, a question, and a public field checkbox. The database field name is a name of a database that is recorded in which data should be saved. The database is connected to the flow builder process and may be stored on the computer, on a different computer, or on a remote server. The field label/title is a heading that is recorded and displayed with the question in the form on the web asset. The question is the question for the flow that will appear on the web asset for answering by a user (e.g., a borrower). The public field checkbox is a field that can be marked by the user of the flow builder process to indicate that a form field is ready to be shown on user-facing forms, meaning to users of the web assets who are providing answers to questions created using the flow builder process. When more than one form field is created using the flow builder process, a form field-based sequence has been created. The data entry field types may also optionally include a hint with the hint being recorded and shown with the question. For example, the hint can explain what certain terminology means or provide other additional information that may be useful or important to the user who is responding to the question via the web asset.

In addition to the common properties described above, which can be included in every field type, the individual field types may also include unique properties. For example, the flow builder may allow its user to designate an appearance in the text and number fields so that a default or custom display may be selected. In another example, the flow builder may include an options property that allows options to be recorded as possible selectable answers for the multiple choice field. In another example, the flow builder process can include a label property for use in the binary answer field so that the answer options are displayed as “yes” and “no” or as two other binary options designated by the user of the flow builder process.

The push process can be a separate process that communicates with the flow builder process. In other embodiments, the push process may be an integrated sub-process of the flow builder process. After a form field-based sequence has been created using the flow builder process, a user of the flow builder process can then instruct the system, using standard control features, to push the updated data (i.e., the form field-based sequence) to the web assets. The push process accomplishes the pushing of the updated data to the web assets by transmitting it to them via the communications network.

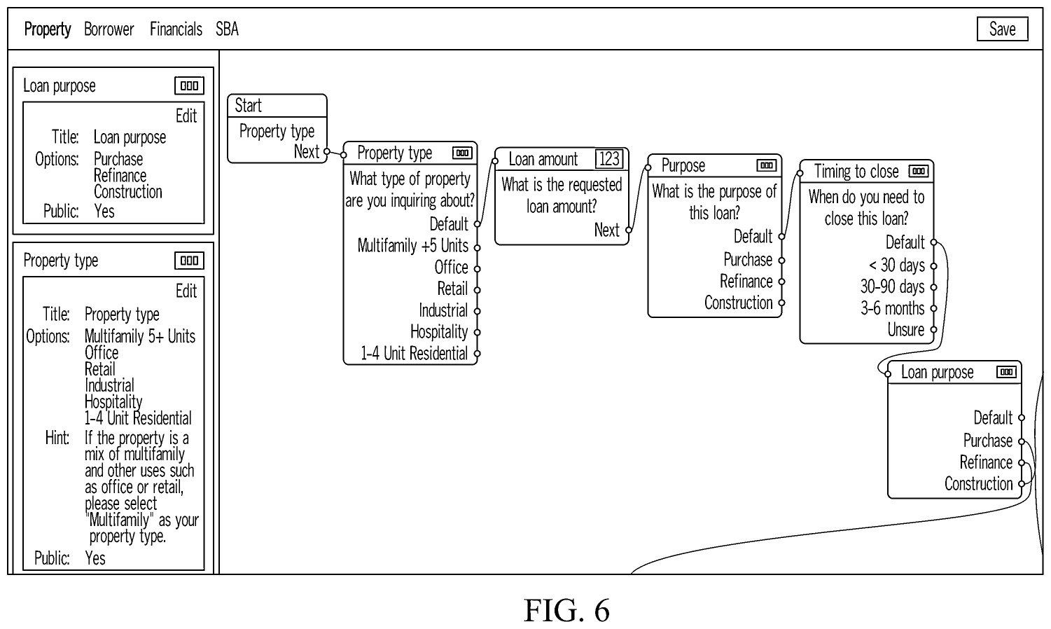

In an exemplary embodiment of the system related to mortgage lending, the flow builder process can include flows: a property flow, a borrower flow, a financials flow, and an SBA flow. As shown in FIG. 6, the property flow can include a plurality of fields, which focus on a property (i.e., a commercial building, land, or other property) that forms the basis of the deal (or loan) application submitted by a potential borrower. The property flow can include questions, for example, concerning the property location, type, make-up, value and price, the loan purpose, and loan amount.

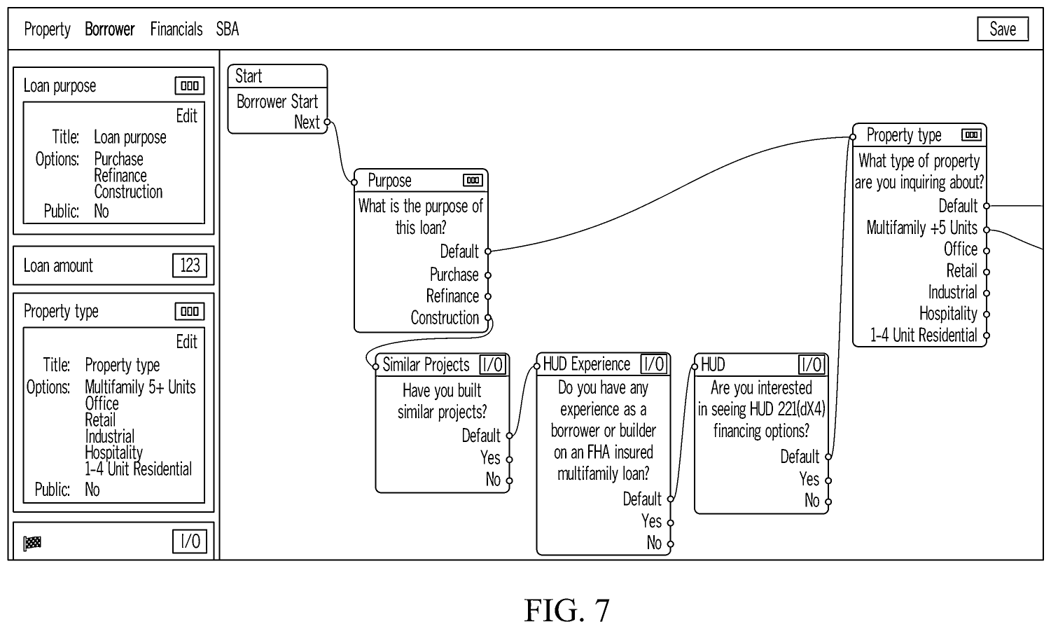

As shown in FIG. 7, the borrower flow also can include a plurality of fields. The fields of the borrower flow can focus on the potential borrower's circumstances and experience as a means of qualifying the borrower for the deal application that the borrow is submitting. The borrower flow can include, for example, questions concerning the loan purpose, property type, and the borrower's current real estate ownership, industry experience, credit score, and partners.

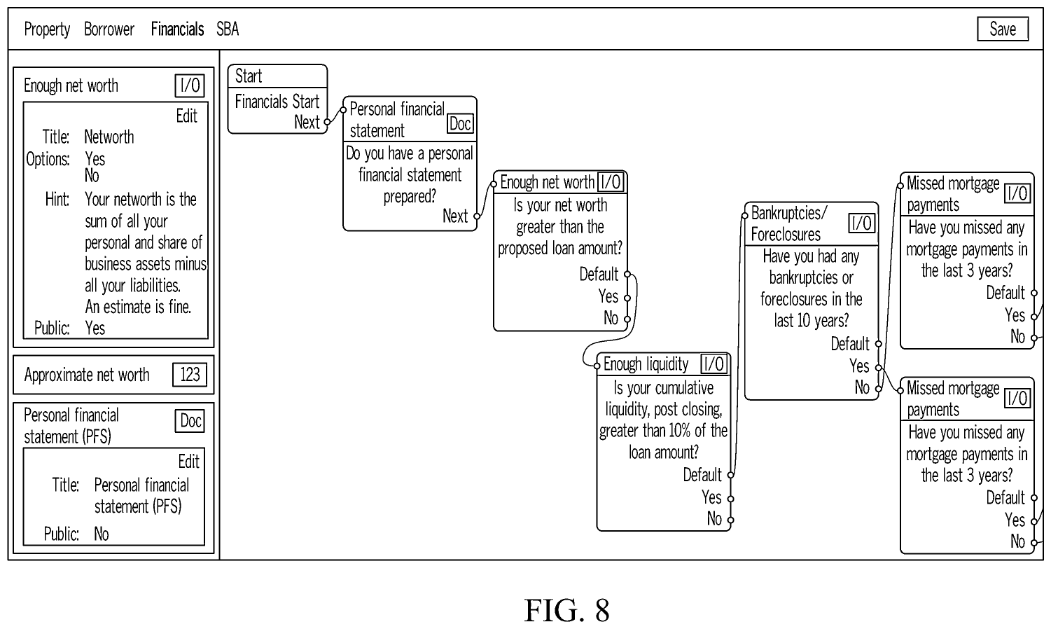

As shown in FIG. 8, the financials flow also can include a plurality of fields, which can focus on the potential borrower's finances as a means of qualifying the borrower for the deal application the borrower is submitting. The financials flow can include, for example, questions concerning the borrower's net worth, liquidity, bankruptcies, and foreclosures.

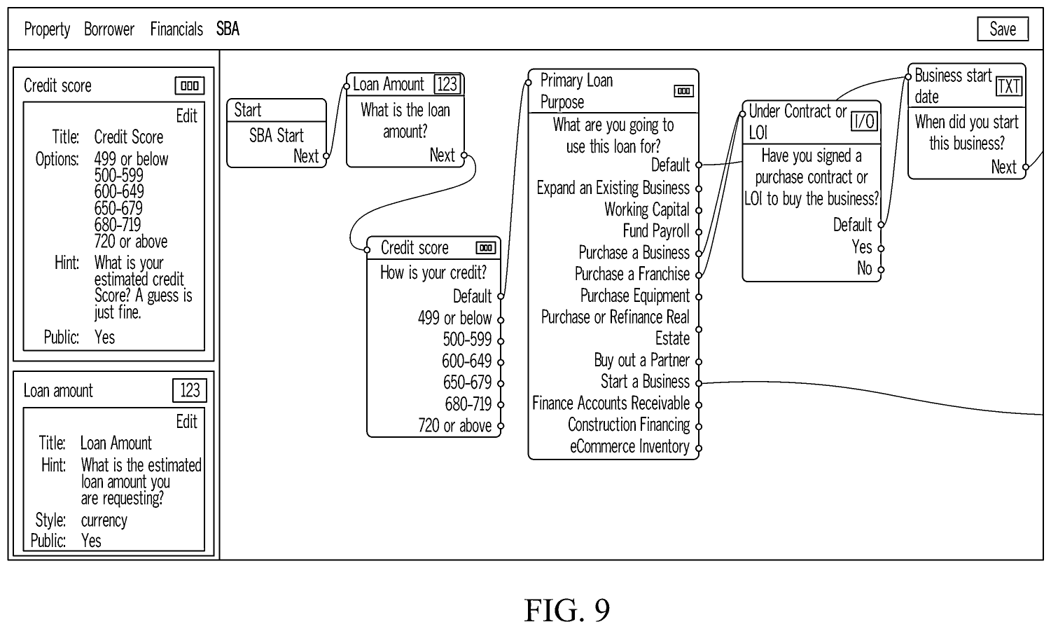

As shown in FIG. 9, the SBA flow, which pertains specifically to deals that would involve financing provided in whole or in part by the federal Small Business Administration, also can include a plurality of fields, which focus on business for which the borrower is submitting a loan application. The SBA flow can include, for example, questions concerning the borrower's business address, annual revenue, current debt, and time in business.

The fields shown in the several flows of FIGS. 6-9 are created using the flow builder process and are then pushed across multiple web assets to collect information from potential borrowers.

The flow builder process is capable of building logic arms through conditional relationships between the fields that present certain questions and bypass others based on the answers given by the user/borrower. The flow builder can incorporate conditional relationships so that any answer value can be followed by any question field, such that, for example, three possible answers can lead to eight possible field flows.

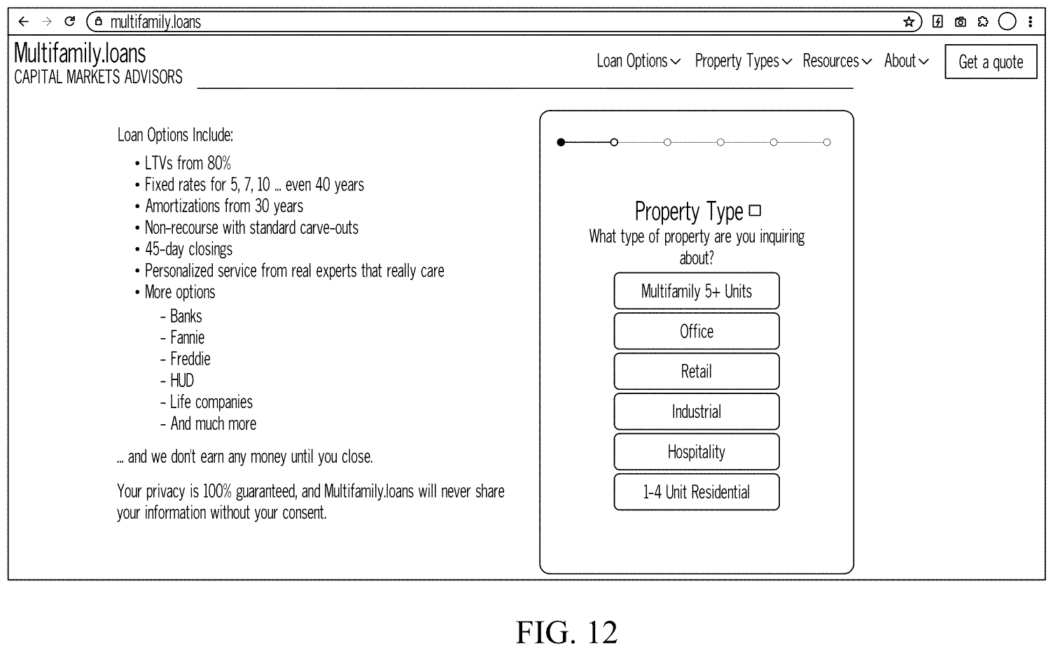

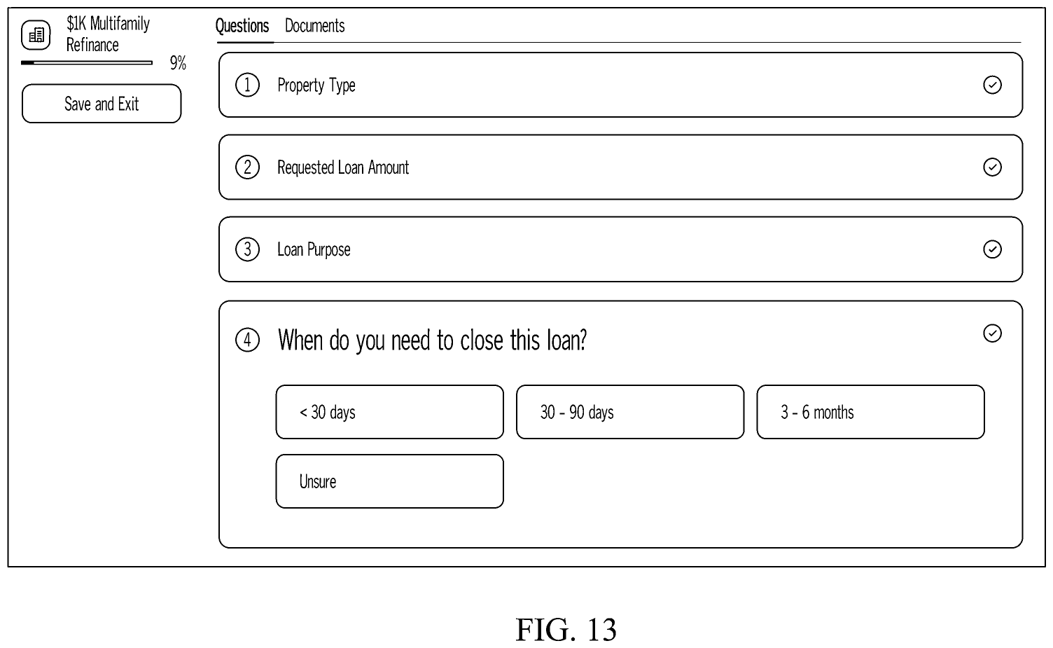

As shown in the examples in FIGS. 11-13, flows created using the flow builder process of the system can be implemented into a multitude of web assets of matching or different types. Upon loading the iframe block on the web asset that contains the flow, the web asset can show a message introducing the flow to the user/borrower accessing the web asset. As shown in FIG. 11, the web asset also can include a button that when clicked or otherwise selected using an input device will enter the user/borrower into the flow. As shown in FIG. 12, when such a flow entry button is clicked, the user/borrower enters the flow and is shown the questions as dictated by the conditional relationships between the questions based on the answers submitted by the user/borrower. The conditional relationships and questions were created by the user of the flow builder process. After a certain predetermined number of responses are collected in the fields, the data is saved to a CRM (e.g., a database saved on a remote server that is accessible to the lender). As shown in FIG. 13, the system may then forward the user/borrower to an in-house portal where the user/borrower can save the loan/deal application and submit it as a package to capital lenders when completed.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for simultaneously providing an update to multiple websites and web-enabled forms, the system comprising:
a computer comprising a processor and associated memory;
an input device communicatively connected to the computer;
a communications network;
at least two web assets, each web asset comprising data;
a flow builder process for creating updated data using the input device and the computer; and
a push process for pushing the updated data from the computer to the at least two web assets via the communications network so that the data of the at least two web assets is changed simultaneously to include or to be replaced by the updated data.

2. The system of claim 1, wherein each of the at least two web assets comprises a website or a web-enabled form.
